(19) United States
(12) Patent Application Publication
(10) Pub. No.: US 2008/0004917 A1
(43) Pub. Date: Jan. 3, 2008

(54) System and method for automatically rebooking reservations

(75) Inventor: William Charles Mortimore, San Francisco, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: Rearden Commerce, Inc.

(21) Appl. No.: 11/479,055

(22) Filed: Jun. 30, 2006

(51) Int. Cl. G06Q 10/00

(52) U.S. Cl. 705/5

(57) ABSTRACT

One embodiment includes a method for automatically rebooking reservations. In one embodiment, the method can be implemented on a system. In one embodiment, changes and cancellations are tracked by service providers, and, if necessary, based on certain preprogrammed rules, automatically respond to the changed situation by changing travel bookings, making new bookings, canceling other existing bookings, and otherwise accommodating and facilitating the new travel arrangements, all in accordance with the traveler's preferences, rather then according to a default offering (or not) of the carrier.

### BACKGROUND OF THE INVENTION

Often, when a traveler takes an extended, multi-leg trip, a carrier, such as an airline, may cancel one or several segments. In some cases, when such a cancellation occurs, the traveler must rebook an alternative travel means (another flight, a train, a car, etc.) for the cancelled trip leg. Such rebooking in a timely manner may be difficult during the trip.

What is clearly needed is a system and method that can track changes and cancellations by service providers, and, if necessary, based on certain preprogrammed rules, automatically respond to the changed situation by changing travel bookings, making new bookings, canceling other existing bookings, and otherwise accommodating and facilitating the new travel arrangements, all in accordance with the traveler's preferences, rather then according to a default offering (or not) of the carrier.

### SUMMARY OF THE INVENTION

One embodiment includes a method for automatically rebooking reservations. In one embodiment, the method can be implemented on a system. In one embodiment, changes and cancellations are tracked by service providers, and, if necessary, based on certain preprogrammed rules, automatically respond to the changed situation by changing travel bookings, making new bookings, canceling other existing bookings, and otherwise accommodating and facilitating the new travel arrangements, all in accordance with the traveler's preferences, rather then according to a default offering (or not) of the carrier.

### BRIEF DESCRIPTION OF THE DRAWINGS

FIG. 1 shows an exemplary system according to one embodiment, containing an electronic services portal and Internet;

FIG. 2 shows an overview of an exemplary storage organization with a trip archive of a customer.

FIG. 3 shows a exemplary screen of a reservation record in accordance with one embodiment;

FIG. 4 shows a exemplary screen of a reservation record in accordance with one embodiment; and

FIG. 5 shows an exemplary process of the method for implementation of the system according to according to one embodiment.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

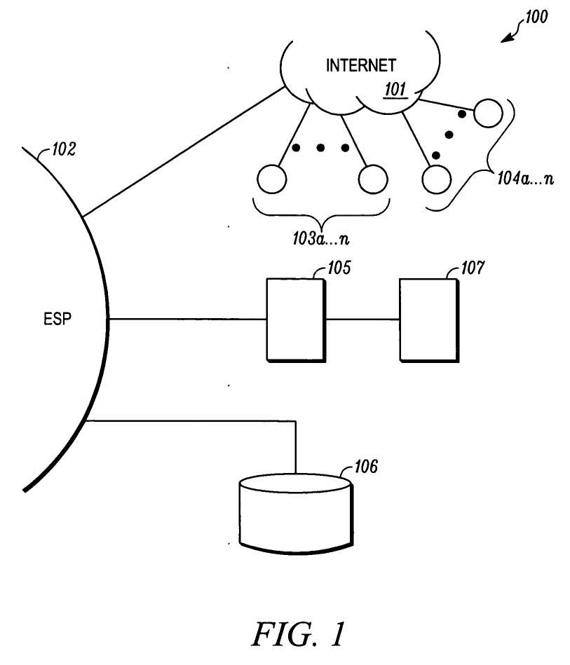

FIG. 1 shows an exemplary system 100 according to the present invention, containing an electronic services portal 102 and Internet 101. Services portal 102 has at least one server 105 with a software instance 107, containing both software for the novel implementation and possibly other software, and also a storage unit 106. Portal 102 is typically connected to Internet 101, as are customers 103 a-n and vendors and suppliers 104 a-n.

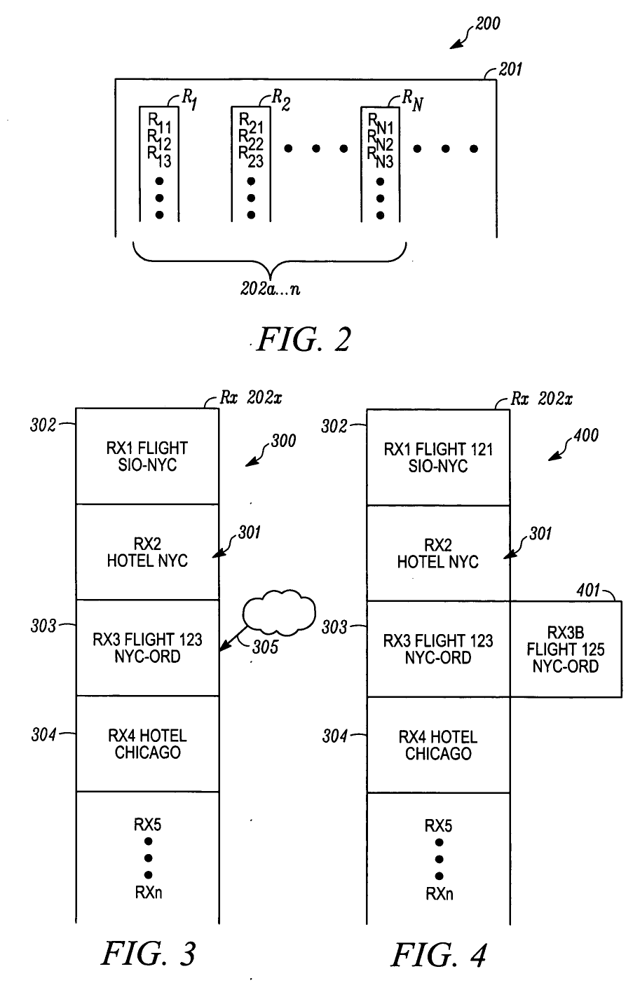

FIG. 2 shows an overview of an exemplary storage organization 200 showing a single trip archive 201 of a customer. It is clear that typically many archives would be present in a system. Shown are reservation sets R1 through Rn 202 a-n. Each reservation set contains multiple single reservations R11, R2, R13 and so forth in R1; R21, R22, R23 and so forth in R2; and Rn1 Rn2, Rn3 and so on in Rn. It is clear that there may be many more reservations in such an archive, and it is also clear that the reservations may have multiple destinations (or only one item), within which a subset of reservations is made for each destination.

FIG. 3 shows a simplified exemplary screen 300 of a specific reservation record Rx 202x. Field 302 shows the first flight Rx1, and field 301 shows a hotel reservation Rx2. Field 303 shows reservation Rx3 for a connecting flight to Chicago, and field 304 shows reservation Rx4 for a hotel in Chicago. Further reservations may be shown in fields Rx5 through Rxn. At the point in time captured in overview 300, the traveler for whom these reservations have been made is currently at the hotel of reservation Rx2. At this time, the system according to the present invention receives a message 305 via the Internet or some other, similar public or private network well known in the art that flight number 123, whose reservation Rx3 is shown in field 303, has been cancelled. The airline may or may not offer to rebook the flight, but, to ensure that the planned trip is carried on as closely to the original bookings as possible, the system would automatically begin to rebook transportation for the traveler.

FIG. 4 shows a simplified exemplary screen 400 of the same reservation record Rx 202x, but with an added field 401 showing reservation Rx3B for flight 125, replacing the cancelled flight 123, so the traveler can continue his journey without interruption or drastic changes in plans.

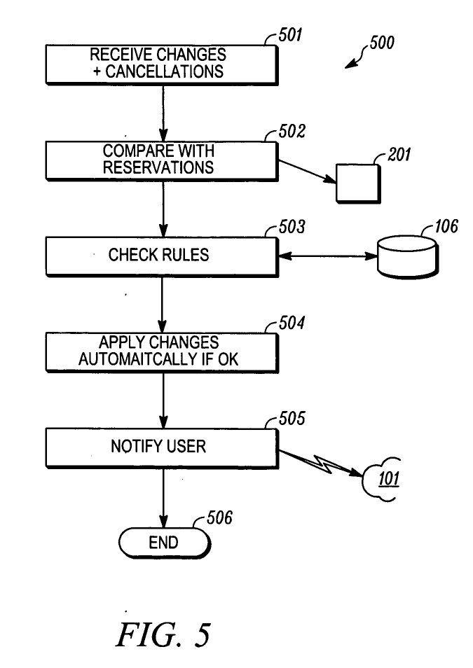

FIG. 5 shows an exemplary process 500 of the method for implementation of the system according to the present invention. In process 501, the system receives changes and cancellations. In process 502 it compares the affected arrangement with reservation records in database 201. The system first checks for affected active trips, but it may also check for future affected trips that are booked. In process 503, the system checks its preprogrammed rules for implementing changes, drawn from data storage unit 106. Such rules may pertain to eligibility of the traveler for certain services, which airlines are preferred for new reservations, how much extra may be paid for replacement reservations, etc. When the system has integrated all data by, for example, a rules and constraints engine, all the allowed changes are applied automatically in process 504. Such changes may include changing reservations and notifying service providers of the applicable changes via the Internet 101 or some other, similar public or private network well known in the art. Then in process 505 the user is notified of the changes to his travel arrangements.

Automatic changes by the system to user bookings may extend beyond just changes to travel means. For example, if a flight is cancelled and rebooked, a limo service must also be notified of the changed time and place for meeting the arriving passenger, and the traveler's hotel may need to be notified to hold the traveler's room for late arrival.

At least some embodiments, and the different structure and functional elements described herein, can be implemented using hardware, firmware, programs of instruction, or combinations of hardware, firmware, and programs of instructions.

In general, routines executed to implement the embodiments can be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects.

While some embodiments have been described in the context of fully functioning computers and computer systems, those skilled in the art will appreciate that various embodiments are capable of being distributed as a program product in a variety of forms and are capable of being applied regardless of the particular type of machine or computer-readable media used to actually effect the distribution.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions can be embodied in digital and analog communication links for electrical, optical, acoustical or other forms of propagated signals, such as carrier waves, infrared signals, digital signals, etc.

A machine readable medium can be used to store software and data which when executed by a data processing system causes the system to perform various methods. The executable software and data can be stored in various places including for example ROM, volatile RAM, non-volatile memory and/or cache. Portions of this software and/or data can be stored in any one of these storage devices.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Some aspects can be embodied, at least in part, in software. That is, the techniques can be carried out in a computer system or other data processing system in response to its processor, such as a microprocessor, executing sequences of instructions contained in a memory, such as ROM, volatile RAM, non-volatile memory, cache, magnetic and optical disks, or a remote storage device. Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's); or firmware such as electrically erasable programmable read-only memory (EEPROM's).

In various embodiments, hardwired circuitry can be used in combination with software instructions to implement the embodiments. Thus, the techniques are not limited to any specific combination of hardware circuitry and software nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent can be reordered and other operations can be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications can be made thereto without departing from the broader spirit and scope of the invention as set forth in the following claims. The specification and drawings are, accordingly, to be regarded in an illustrative sense rather than a restrictive sense.

What is claimed is:

1) A method comprising:
A system receiving one of changes and cancellations for travel reservations of a user;
comparing affected reservations with reservation records in a database
automatically providing the user with a proposed substitute travel reservation, based on a set of predefined rules.

2) The method of claim 1, further comprising the system first checking for affected active reservations.

3) The method of claim 2, further comprising the system checking for future affected reservations.

4) The method of claim 1, wherein the predefined rule includes determining at least one of a preferred airline of the user and an amount to be paid for replacement reservations, previously identified by the user.

5) A system comprising:
A means for receiving one of changes and cancellations for travel reservations of a user;
A means for comparing affected reservations with reservation records in a database
A means for automatically providing the user with a proposed substitute travel reservation, based on a set of predefined rules.

6) The system of claim 5, wherein the means for receiving further comprises a means for checking for affected active reservations.

7) The system of claim 6, wherein the means for receiving further comprises a means checking for future affected reservations.

8) The system of claim 5, wherein the predefined rule includes determining at least one of a preferred airline of the user and an amount to be paid for replacement reservations, previously identified by the user.

9) A machine readable medium having stored thereon a set of instructions which when executed perform a method comprising:
A means for receiving one of changes and cancellations for travel reservations of a user;
A means for comparing affected reservations with reservation records in a database
A means for automatically providing the user with a proposed substitute travel reservation, based on a set of predefined rules.

10) The machine readable medium of claim 9, wherein the means for receiving further comprises a means for checking for affected active reservations.

11) The machine readable medium of claim 10, wherein the means for receiving further comprises a means checking for future affected reservations.

12) The machine readable medium of claim 9, wherein the predefined rule includes determining at least one of a preferred airline of the user and an amount to be paid for replacement reservations, previously identified by the user.
